(19) United States
(12) Patent Application Publication
(10) Pub. No.: US 2015/0275156 A1
(43) Pub. Date: Oct. 1, 2015

(54) WATER SOLUBLE UNIT DOSE ARTICLE

(71) Applicant: The Procter & Gamble Company, Cincinnati, OH (US)

(72) Inventors: Philip Frank SOUTER, Northumberland (GB); Alan Thomas BROOKER, Newcastle upon Tyne (GB); Robby Renilde Francois KEULEERS, Lippelo (BE)

(21) Appl. No.: 14/669,562

(22) Filed: Mar. 26, 2015

(30) Foreign Application Priority Data
Mar. 28, 2014 (EP) 14162444.5

(51) Int. Cl. C11D 17/04; C11D 3/33; C11D 3/36

(52) U.S. Cl. CPC C11D 17/045; C11D 3/36; C11D 3/33; C11D 3/365

(57) ABSTRACT

A multicompartment water-soluble unit dose article comprising a water-soluble film, wherein a first compartment comprises a powder composition and a second compartment comprises a liquid composition, and
wherein the unit dose article comprises a top wall, a bottom wall, an inner wall and an outer wall, and wherein the first compartment is defined as the internal space between the top wall, the bottom wall and the inner wall, and wherein the second compartment is defined as the internal space between the inner wall, the outer wall, the top wall and the bottom wall, and wherein the walls comprise the water-soluble film, and a method of using said unit dose article.

### FIELD OF THE INVENTION

Water soluble unit dose articles and methods of using thereof.

### BACKGROUND OF THE INVENTION

Water soluble unit dose articles have become very popular with the consumer. Such articles are usually constructed of one or more water-soluble films shaped to provide at least one internal compartment. Contained within the internal compartment is a detergent composition. Upon addition to water, the water-soluble film dissolves releasing the composition in to the wash liquor.

Such unit dose articles can be used in automatic laundry washing machines or automatic ware washing operations (such as automatic dish washing). The unit dose article is added to the drum, or internal space of the washing machine together with the fabrics/garments or ware items to be washed. Upon addition of water to the wash process, the water-soluble film dissolves releasing the composition into the wash liquor.

Multicompartment unit dose articles provide the added benefit of being able to separate incompatible ingredients into the different compartments. This is often achieved by having a powder composition and a liquid composition. Upon addition of water, the contents of the separate compartments are released and the various ingredients are free to provide their individual benefits during the wash. However, during storage and ahead of use, these ingredients are not in contact with one another.

The compartments are either arranged in a superposed orientation (i.e. on top of one another), or in a side-by-side orientation. However, an issue with known side-by-side orientated unit dose articles is the lack of structural rigidity between the compartments. Often the compartments are separated by a ‘bridge’ or ‘connector’ made of water-soluble film. This means that when the consumer picks up the unit dose article it appears ‘floppy’ since there is differential movement between the compartments. If the consumer holds one compartment, the weight of the composition of the other compartment makes it ‘sag’ down, hence making the unit dose article appear ‘floppy’. The consumers equate this with ‘cheap’ product or ‘lacking cleaning chemistry’. Furthermore, such unit dose articles may suffer from unplanned rupturing. This is due to the weight of one compartment putting undue load pressure on the film causing it to overstretch and rupture in the bridge region or the second compartment or both.

There remains a need in the art for providing incompatible ingredients to a wash operation in a consumer accepted manner.

It was surprisingly found a multicompartment unit dose article a powder and a liquid composition and wherein the unit dose article comprises a top wall, a bottom wall, an inner wall and an outer wall, and wherein the first compartment is defined as the internal space between the top wall, the bottom wall and the inner wall, and wherein the second compartment is defined as the internal space between the inner wall, the outer wall, the top wall and the bottom wall, and wherein the walls comprise the water-soluble film overcame this and other technical issue.

### SUMMARY OF THE INVENTION

A first aspect of the present invention is a multicompartment water-soluble unit dose article comprising a water-soluble film, wherein a first compartment comprises a powder composition and a second compartment comprises a liquid composition, and wherein the unit dose article comprises a top wall, a bottom wall, an inner wall and an outer wall, and wherein the first compartment is defined as the internal space between the top wall, the bottom wall and the inner wall, and wherein the second compartment is defined as the internal space between the inner wall, the outer wall, the top wall and the bottom wall, and wherein the walls comprise the water-soluble film.

A second aspect of the present invention is a method of laundry comprising the step of adding a unit dose article according to the present invention to the drum of an automatic laundry washing machine.

### DETAILED DESCRIPTION OF THE INVENTION

### Multicompartment Unit Dose Article

The present invention is to a multicompartment water-soluble unit dose article comprising a water-soluble film, wherein a first compartment comprises a powder composition and a second compartment comprises a liquid composition.

The unit dose article comprises a top wall, a bottom wall, an inner wall and an outer wall and the walls comprise the water soluble film. The unit dose article may be formed from a single water soluble film or from more than one water-soluble film. The unit dose article may comprise two water soluble films. The first film may be moulded so as to define the bottom wall and the inner and outer walls of the unit dose article, and the second film is used to define the top wall of the compartment. Alternatively the first film may define the bottom wall and at least partially the bottom wall and the inner and outer walls and the second film defines the top wall and at least partially the inner and outer walls.

The first and second films are sealed together. Any suitable sealing means may be used, including, but not limited to, heat sealing, solvent sealing, pressure sealing, ultrasonic sealing, pressure sealing, laser sealing or a combination thereof.

The outer wall at least partially surrounds the inner wall. In other words, the outer wall substantially follows the contours of the inner wall, such that the internal space between the inner and outer wall and the top and bottom walls defines second compartment. Preferably, the outer wall completely surrounds the inner wall, such that the second compartment is formed completely around the circumference of the first compartment. However, the first compartment is not orientated completely within the internal volume of the second compartment. The second compartment may have a generally tubular shape that surrounds the first compartment.

At least part of the inner wall may define the first and second compartments. By this, we herein mean that the full height of the inner wall does not need to define the first and second compartments. In other words, part of the height of the inner wall may not define either compartment and/or be in contact with either the first or second compositions.

The outer wall may remain substantially equidistant to the inner wall along the full length of the inner wall. In other words, the distance between the outer wall and inner wall remains constant along the entire length of the inner wall, such that the peripheral shape of the outer wall follows the peripheral shape of the inner wall. Or in other words, the shape of the second compartment follows the shape of the first compartment.

Without wishing to be bound by theory, the shape of the second compartment, i.e. wherein it forms a perimeter around the first compartment, adds structural rigidity to the unit dose article. This is because the two compartments cannot move about a flexible ‘bridge’ region. It was also surprisingly found that the unit dose article was more resistant to rupture of the film. This was because the orientation of the compartments of the present invention better balanced the load of the compositions. Where a bridge region is present, the weight of one compartment can put undue load pressure on the film causing it to overstretch and rupture.

The top and bottom walls of the first and second compartments are in contact with the external environment. Therefore the first and second compartments are not superposed upon one another.

The inner wall may comprise a first inner wall and a second inner wall. The first inner wall has a first side and a second side, and the second inner wall has a first side and a second side, and the entire length of one side of the first inner wall is facing the second inner wall. The first inner wall and the second inner wall may have the same or a different height. The first inner wall is contact with the first compartment and the second inner wall is in contact with the second compartment. The first inner wall and the second inner wall may be at least partially in contact with one another. The first inner wall and the second inner wall maybe completely in contact with one another. The first inner wall and the second inner wall may be sealed together. The first inner wall and the second inner wall may be at least partially separated from one another. For example, there may be a gap between the first inner wall and the second inner wall. Therefore, the first inner wall the second inner wall together define the separation between the first and second compartments. If the first inner wall and the second inner wall are separated by a gap, then the gap may be between 1 micron and 5 mm, or even between 50 microns and 2 mm or even between 100 microns and 1 mm. Preferably, the outer wall completely surrounds the inner wall, such that the second compartment is formed completely around the circumference of the first compartment. However, the first compartment is not orientated completely within the internal volume of the second compartment. The second compartment may have a generally tubular shape that surrounds the first compartment. The top wall and the bottom walls of both compartments are in contact with the external environment.

The first inner wall and the second inner wall may be defined by the same or a different film. The top wall and the first inner wall may be defined by a first film and the second inner wall and the bottom wall by a second film. Alternatively, the bottom wall and the first and the second inner walls may be defined by a first film and the top wall defined by a second film. Alternatively, a first film may define the top wall and at least part of the first inner and second inner walls, and a second film may define the bottom and at least part of the first inner and second inner walls.

Without wishing to be bound by theory, it may be advantageous to have a first and second inner wall in order to minimise migration of ingredients from one compartment to the other. For example, water in the composition of one compartment may migrate into the other compartment, This is especially disadvantageous if the cleaning active in one compartment is bleach for example, and/or the composition in one compartment is a powder.

The first compartment may have any suitable shape. For example, the first compartment may be substantially square, rectangular, circular, elliptical, superelliptical or oval shape. By ‘substantially’, we herein mean that the general shape of the compartment is square, rectangular, circular, elliptical, superelliptical or oval shape, but the shape of the compartment may have imperfections such as small indents or protrusions.

The unit dose article has a height, a length and a width, wherein the maximum height is between 1 and 5 cm, or even between 1 and 4 cm, the maximum length is between 2 and 8 cm, or even between 3 and 7 cm, and the maximum width is between 2 and 8 cm or even between 3 and 7 cm. The maximum of any of these dimensions is meant to mean the greatest distance between two points on opposite sides of the unit dose article. In other words, the unit dose article may not have straight sides and so may have variable lengths, widths and heights depending on where the measurement is taken. Therefore, the maximum should be measured at any two points that are the furthest apart from each other.

The unit dose article may excess material present as a flange or skirt at the point where two or more films are sealed together. This flange or skirt may be included or may not be included in the maximum length, width and height.

The unit dose article has a maximum height, a maximum length, and a maximum width, and the first compartment has a maximum height, a maximum length and a maximum width. Preferably, the ratio of the maximum height of the first compartment to the maximum height of the unit dose article is between 1:2 and 2:1; the ratio of the maximum length of the first compartment to the maximum length of the unit dose article is between 1:1.5 to 1:3; the ratio of the maximum width of the first compartment to the maximum width of the unit dose article is between 1:1.5 to 1:3.

The ratio of the maximum height of the second compartment to the maximum height of the unit dose article may be between 1:2 and 2:1; the ratio of the maximum length of the second compartment to the maximum length of the unit dose article may be between 1:1.5 to 1:3; the ratio of the maximum width of the second compartment to the maximum width of the unit dose article may be between 1:1.5 to 1:3.

Without wishing to be bound by theory, it was surprisingly found that the orientation of the first and second compartments such that the second compartment surrounds the first compartment improved the structural integrity of the unit dose article. In other words it was perceived by consumers to be less ‘floppy’. However, it still fulfilled the purpose of allowing the separation of incompatible ingredients during storage.

Preferably, the unit dose article ruptures between 10 seconds and 5 minutes once the unit dose article has been added to 950 ml of deionised water at 20-21° C. in a 1 L beaker, wherein the water is stirred at 350 rpm with a 5 cm magnetic stirrer bar. By rupture, we herein mean the film is seen to visibly break or split. Shortly after the film breaks or splits the internal liquid detergent composition may be seen to exit the unit dose article into the surrounding water.

The unit dose article comprises a powder composition and a liquid composition. The powder composition is comprised in the first compartment and the liquid composition is comprised in the second compartment. The term ‘powder’ includes powders, granules, particles, solids and mixtures thereof. The powder composition may be a free flowing powder or a compacted powder or a mixture thereof. The term ‘liquid’ includes liquids, gel, paste, dispersion, fluid or a mixture thereof. The pH of the liquid composition may be between 5 and 9, preferably between 6 and 8. Preferably, the liquid composition comprises between 0.5% and 30%, or even between 1% and 20%, or even between 2% and 15% by weight of the liquid composition of water. Preferably the unit dose article comprises between 0.5% and 30%, or even between 1% and 20%, or even between 2% and 15% by weight of the unit dose article.

The weight ratio of the powder composition to the liquid composition in the unit dose article is from 3:1 to 1:3.

The powder composition may comprise a first cleaning active and the liquid composition may comprise a second cleaning active and the first and second cleaning actives are incompatible with one another. By ‘incompatible’ we herein mean the ingredients would interact we each other in a detrimental manner, for example they may react such that one or both are broken down. This means that one or both ingredients are not available during the wash process to provide their respective benefits. Those skilled in the art will recognize suitable incompatible ingredients to be the first and second cleaning actives.

Without wishing to be bound by theory it is preferred that one of the compositions is in powder form. This has the added benefit of increasing the dissolution time of the powder composition when it interacts with water versus the liquid composition and so reduces the potential interaction of the incompatible actives at the point they are released from the unit dose article. At the point of release there may exist high concentrations of the cleaning compositions in the wash liquor, before they are dispersed throughout the wash liquor. By slowing the dissolution of one of the actives, there is less chance of the incompatible actives negatively interacting in the area of temporary high concentration.

The unit dose article may be a thermoformed unit dose article. Preferably, the film is thermoformed such that the film of the resultant unit dose article retains a degree of flexibility or elasticity such that it allows referred structural integrity. If the film is too rigid then it may break/split due to the internal forces provided by the compositions.

The unit dose article may be a laundry unit dose article or a household care unit dose article. Suitable laundry unit dose articles include laundry cleaning articles including laundry detergent articles, laundry pre-treat articles, or laundry treatment articles including laundry care articles, laundry freshness articles, laundry softening articles or mixtures thereof. Suitable household care articles include automatic dishwashing articles, hard surface cleaner articles, hand wash articles and mixtures thereof. Preferably, the unit dose article is a laundry cleaning article.

### Powder Composition

The powder composition may comprise a first cleaning active. The first cleaning active can be any suitable cleaning active that is incompatible with the second cleaning active. The first cleaning active may be selected from bleach, enzymes, surfactant, polymers, perfumes or a mixture thereof. The first cleaning active may be selected from bleach, enzymes and a mixture thereof. The first cleaning active may be bleach. The first cleaning active may be an enzyme. Preferably the first cleaning active is an enzyme, a bleach or a mixture thereof. Without wishing to be bound by theory, this is preferable as the powder composition is more likely to release first into the wash liquor during the wash process. This means that the bleach and enzymes are released first and have the opportunity to provide cleaning benefit to the fabrics first. This has the advantage that the enzymes and bleach are not concentrated in the wash liquor to react with other ingredients including the second cleaning active, rather the majority of the enzyme and/or bleach is available to act on the fabrics. This also means that the majority of the other cleaning actives are available to act on the fabrics and not react with the enzyme and/or bleach. Preferably the first cleaning active retains an activity of at least 25%, or even 50% or even 75% after 8 weeks storage. ‘Storage’ is understood to begin at the point when the unit dose article is formed.

The powder composition may be substantially free of the second cleaning active, in other words, the second cleaning active is present only in the powder composition. By ‘substantially free’ we herein mean the second cleaning active is not intentionally added to the powder composition.

Preferably the powder composition comprises a desiccating agent. Those skilled on the art will recognize suitable desiccating agents. Without wishing to be bound by theory, the desiccating agent will help remove free water that could otherwise interact with the cleaning active, especially if the cleaning active is a water-sensitive active, such as bleach for example.

The powder composition may comprises glycerol. Without wishing to be bound by theory, glycerol is a plasticizer for the water-soluble film. The powder composition may draw the glycerol away from the film so detrimentally affecting the plasticity, and hence the structural integrity and rigidity. Glycerol present in the powder can prevent the transfer of glycerol from the film as an equilibrium may be obtained between the film and the powder whilst still maintaining a sufficient concentration of glycerol in the film.

The powder composition may comprise any further adjunct cleaning ingredients.

### Liquid Composition

The liquid composition may comprise a second cleaning active. The second cleaning active can be any suitable cleaning active that is incompatible with the first cleaning active. The second cleaning active may be selected from surfactant, polymers, perfumes, bleach, enzymes or a mixture thereof. The second cleaning active may be selected from surfactant, polymers, perfumes and a mixture thereof. Preferably the first cleaning active retains an activity of at least 25%, or even 50% or even 75% after 8 weeks storage. ‘Storage’ is understood to begin at the point when the unit dose article is formed.

The liquid composition may be substantially free of the first cleaning active, in other words, the first cleaning active is present only in the liquid composition. By ‘substantially free’ we herein mean the first cleaning active is not intentionally added to the liquid composition.

The liquid composition may comprise any further adjunct cleaning ingredients.

Preferably the liquid composition comprises a gelling agent or a structurant. Those skilled in the art will recognize suitable gelling or structurant agents. Without wishing to be bound by theory, the presence of a gelling agent or a structurant may help to ‘lock away’ any free water and reduce the chances of it migrating into the powder composition. This is especially beneficial if the powder composition comprises a water-sensitive cleaning active such as bleach. Also it is preferable since addition of water to the powder may cause it to ‘cake’ making dissolution of the powder slower when the unit dose article is added to water.

Bleach may be present in either composition or both compositions. Bleach may be present in powder or liquid compositions, preferably powder compositions. Suitable bleaching agents include photobleaches, bleach activators, hydrogen peroxide, sources of hydrogen peroxide, preformed peracids, bleach catalysts and mixtures thereof. In general, when a bleaching agent is used, the composition may comprise from about 0.1% to about 50% or even from about 0.1% to about 25% bleaching agent by weight of the composition. Examples of suitable bleaching agents include:
(1) photobleaches for example sulfonated zinc phthalocyanine;
(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxzone®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;
(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and
(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NO.

Preferably the bleach comprises percarbonate. Also preferred are bleaches comprising coated percarbonate and coated or uncoated PAP or coated percarbonate and coated or uncoated DAP.

The composition may comprise coated bleach particles. The particles are coated preferably with a compound selected from the group comprising sodium sulphate, sodium citrate, sodium borate, sodium carbonate, sodium bicarbonate, sodium silicate or mixtures thereof. In one aspect, the particles are coated with an efflorescent material, preferably with sulphate or citrate, more preferably with sodium sulphate. The bleach particles comprise at least 3%, or at least 4% or at least 5% by weight of the particle of coating, preferably from about 5% to about 20%, more preferably from about 6% to about 15% and especially from about 7% to about 12% by weight of the particle of a coating, preferably an efflorescent material.

Inorganic and organic bleaches are suitable bleaches for use herein. Inorganic bleaches include perhydrate salts such as perborate, percarbonate, perphosphate, persulfate and persilicate salts. The inorganic perhydrate salts are normally the alkali metal salts. Alkali metal percarbonates, particularly sodium percarbonate are preferred perhydrates for use herein. The percarbonate is incorporated into the products in a coated form which provides in-product stability and anti-caking properties.

The literature describes a large number of materials that can be used as coating for bleach, however the literature does not address the problem of caking of bleach particles or temperature cycle stable bleach particles (i.e. bleach particles capable of withstand temperature changes). For the present invention the bleach needs to be coated with efflorescent material, preferably with sulphate or citrate, more preferably with sodium sulphate. The coating can comprise other materials but preferably the coating comprises less than 40%, more preferably less than 20% and even more preferably less than 10% and especially less than 1% by weight of the coating of other materials, i.e., preferably the coating consist essentially of efflorescent materials, more preferably the coating consist essentially of sodium sulphate.

Especially preferred for use herein are percarbonate particles comprising a core substantially consisting of bleach, preferably sodium percarbonate, and a coating layer enclosing this core comprising an efflorescent material, preferably sodium sulphate. The core can be produced by fluidised bed spray granulation and the coating layer can be obtainable by spraying an aqueous efflorescent material, preferably sodium sulphate solution onto the uncoated particles of bleach. The fluidised bed temperature is from 35 to 100° C. to allow for water evaporation. In the case in which the efflorescent material is sodium sulphate, the fluidised bed temperature during application of the coating layer is maintained above the transition temperature of the decahydrate (32.4° C.).

In a further aspect the bleach particles can be coated bleach particles comprising a core and at least two coating layers. Specifically, the coated bleach particles can comprise an inner layer of efflorescent materials at least partially enclosing the core and firmly adhering thereto, and an outer layer of water-insoluble materials at least partially enclosing the inner layer and firmly adhering thereto. In one embodiment, the bleach particle comprises a core substantially consisting of bleach, in one embodiment sodium percarbonate; an inner layer comprising efflorescent materials; and an outer layer substantially comprising water-insoluble materials, in one embodiment, sodium silicate.

Coated bleach particles comprise a core substantially consisting of bleach. In one embodiment, the core substantially consists of sodium percarbonate. The term “substantially” is taken to mean that, as a result of the production process, the core may contain small quantities of auxiliary substances, i.e. substances other than bleach. The auxiliary substances may be present in an amount of less than 10%, in another embodiment less than 5%, in another embodiment less than 1%, by weight of the core. The auxiliary substances may be active oxygen stabilisers, for example, silicates and/or magnesium compounds. The auxiliary substances may also be inorganic or organic compounds which are used as nuclei in fluidised bed spray granulation for the production of sodium percarbonate, for example, the production of soda.

In one embodiment, the coated bleach particles comprise an inner layer of efflorescent materials at least partially enclosing the core and firmly adhering thereto. The inner layer substantially consists of an efflorescent material which may be partially hydrated. Suitable efflorescent materials include sodium sulphate, sodium carbonate, and mixtures thereof. The bleach particle of the invention does not need a thick inner layer in order to provide stability benefits. In one embodiment, the inner layer is from about 2% to about 10%, in another embodiment from about 3% to about 8%, by weight of the total bleach particle.

In one embodiment, the coated bleach particles comprise an outer layer of water-insoluble materials at least partially enclosing the inner layer and firmly adhering thereto. The outer coating layer substantially consists of a water-insoluble material. Suitable water-insoluble materials include alkali metal silicate, in one embodiment, sodium silicate. Said sodium silicate has a silicate ratio of from about 2.5 to about 4.5, in another embodiment from about 2.9 to about 4, and in another embodiment from about 3 to about 3.4. By “water-insoluble” it is meant a material that has a solubility of less than 0.01 g/cm³ at a temperature of about 20° C. In one embodiment, the outer layer comprises from about 0.2% to about 1.5 wt. %, in another embodiment from about 0.5% to 1 wt. % sodium silicate.

It is believed that the outer layer of water-insoluble materials, in one embodiment silicate, offers sufficient encapsulation to provide stability benefits while also containing large enough defects in the outer layer that the bleach (in one embodiment, percarbonate), is released into the wash liquor in a desirable timeframe. In one embodiment, greater than 80% of the core substantially comprising bleach is released in less than 10 minutes, in another embodiment less than 7 minutes into the wash liquor. Too thick of an outer layer delays release of the core (and therefore diminishes bleach performance) whereas too thin of an outer layer will not provide the stability benefits in the detergent composition.

In one embodiment, the water-insoluble outer layer is a thermally sensitive material that is solid at room temperature but melts in the temperature range of from about 30° C. to about 60° C., in another embodiment from about 35° C. to about 45° C. The outer layer can provide protection from water ingress during storage while being able to release the bleach core under typical automatic dishwashing wash conditions (40° C. to about 60° C. wash cycles).

Preparation of the coated bleach particles comprises coating processes which are known in the art; in one embodiment, fluidized bed coating. Fluidized bed coating is characterized in that for the preparation of an outer shell layer comprising, for example alkali metal silicate, an aqueous solution containing alkali metal silicate with an alkali metal silicate concentration in the range from about 2% to about 20 wt. %, and a silicate ratio of greater than 2.5, is used. This solution is sprayed onto, for example, sodium percarbonate particles which have at least one inner layer comprising an efflorescent material. The spraying is carried out in a fluidized bed, with simultaneous evaporation of water, until the outer layer comprises from about 0.2% to about 1.5 wt. % alkali metal silicate.

So that good stabilising may be achieved, endeavours are taken during production to obtain a stabilized coated bleach particle having the lowest possible degree of hydration. For this reason, the fluidised bed temperature during application of the inner layer to the core and the outer layer to the inner layer is maintained above the transition temperature of the decahydrate (32.4° C.).

The resulting coated bleach particle has a weight geometric mean particle size of from about 400 μm to about 1200 μm, in one embodiment from about 500 μm to about 1000 μm, and in another embodiment from about 700 μm to about 900 μm. It is beneficial that the bleach particles have a low level of fine and coarse particles; in one embodiment less than 10% by weight of the bleach particles have a size above about 1400 μm, in another embodiment above 1200 μm or below about 400 μm, in another embodiment below about 200 μm. The mean particle size and particle size distribution further contributes to the stability of the detergent composition. In one embodiment, the coated bleach particle has a weight geometric mean particle size of from about 700 to about 1000 μm, with less than about 3% by weight of the bleach particle above about 1180 μm and less than about 5% by weight of the bleach particle below about 200 μm. The weight geometric mean particle size can be measured using a Malvern particle size analyser based on laser diffraction.

The detergent composition comprises from about 3% to about 30%, in another embodiment from about 5% to about 20%, and in another embodiment from about 7% to about 15%, bleach particle by weight of the composition.

The bleach can be coated using a plurality of processes, for example by coating in a fluidised bed. Details of the process are found at EP 862 842 A1 and U.S. Pat. No. 6,113,805.

Potassium peroxymonopersulfate is another inorganic perhydrate salt of utility herein.

Typical organic bleaches are organic peroxyacids including diacyl and tetraacylperoxides, especially diperoxydodecanedioc acid, diperoxytetradecanedioc acid, and diperoxyhexadecanedioc acid. Dibenzoyl peroxide is a preferred organic peroxyacid herein. Mono- and diperazelaic acid, mono- and diperbrassylic acid, and Nphthaloylaminoperoxicaproic acid are also suitable herein.

The diacyl peroxide, especially dibenzoyl peroxide, should preferably be present in the form of particles having a weight average diameter of from about 0.1 to about 100 microns, preferably from about 0.5 to about 30 microns, more preferably from about 1 to about 10 microns. Preferably, at least about 25%, more preferably at least about 50%, even more preferably at least about 75%, most preferably at least about 90%, of the particles are smaller than 10 microns, preferably smaller than 6 microns. Diacyl peroxides within the above particle size range have also been found to provide better stain removal especially from plastic dishware, while minimizing undesirable deposition and filming during use in automatic dishwashing machines, than larger diacyl peroxide particles. The preferred diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the bleach coated particles have a weight geometric mean particle size of from about 300 μm to about 1200 μm, more preferably from about 400 μm to about 1000 μm and especially from about 500 μm to about 900 μm. Preferably the bleach coated particles have low level of fines and coarse particles, in particular less than 10% by weight of the particles are above about 1400, more preferably about 1200 or below about 200, more preferably about 100 μm. These mean particle size and particle size distribution further contribute to the excellent processing properties of the composition of the invention. In especially preferred embodiments, from the processing point of view, the particles have a weight geometric mean particle size of from about 500 to about 1000 μm with less than about 3% by weight of the polymer above about 1180 μm and less than about 5% by weight of the particles below about 200 μm. The weight geometric mean particle size can be measured using a Malvern particle size analyser based on laser diffraction.

The compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. The enzyme may be a lipase. When present in a fabric and home care product, the aforementioned enzymes may be present at levels from about 0.00001% to about 2%, from about 0.0001% to about 1% or even from about 0.001% to about 0.5% enzyme protein by weight of the fabric and home care product.

In one aspect preferred enzymes would include a protease. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, B. alkalophilus, B. subtilis, B. amyloliquefaciens, Bacillus pumilus and Bacillus gibsonii described in U.S. Pat. No. 6,312,936 B1, U.S. Pat. No. 5,679,630, U.S. Pat. No. 4,760,025, U.S. Pat. No. 7,262,042 and WO09/021867.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, including those derived from Bacillus amyloliquefaciens described in WO 07/044993A2.

Preferred proteases include those derived from Bacillus Lentus and Bacillus amyloliquefaciens, preferably comprising a substitution, insertion or deletion at one or more positions corresponding to (versus the standard BPN′ numbering system): 3, 4, 9, 15, 68, 76, 116, 127, 99, 101, 103, 104, 87, 76, 167, 194, 199, 217 and 245, wherein preferably at least one of said mutations is selected from group comprising S3, V4I, S9R, A15T, V68A, N76D, S101M/N, Y167F, Y217Q and S78N.

Suitable commercially available protease enzymes include those sold under the trade names Alcalase®, Savinase®, Primase®, Durazym®, Polarzyme®, Kannase®, Liquanase®, Liquanase Ultra®, Relase®, Relase Ultra®, Savinase Ultra®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V2051+L217D), BLAP X (BLAP with S3T+V4I+V2051) and BLAP F49 (BLAP with S3T+V4I+A194P+V199M+V2051+L217D)—all from Henkel/Kemira; and KAP (Bacillus alkalophilus subtilisin with mutations A230V+S256G+S259N) from Kao.

The protease may in a liquid composition or a powder composition. Preferably the protease is present in the powder composition.

Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.

(b) the variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:

26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.

(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.

(d) variants exhibiting at least 95% identity with the wild-type enzyme from Bacillus sp.707 (SEQ ID NO:7 in U.S. Pat. No. 6,093,562), especially those comprising one or more of the following mutations M202, M208, 5255, R172, and/or M261. Preferably said amylase comprises one or more of M202L, M202V, M2025, M202T, M202I, M202Q, M202W, S255N and/or R172Q. Particularly preferred are those comprising the M202L or M202T mutations.

(e) variants exhibiting at least 80% identity, at least 90%, preferably at least 95%, or at least 98%, or 99% or 100% identity with the truncated version of the wild-type from TS23 (SEQ ID NO:2 in WO2010/115021) that comprise one or more mutations at the following positions: 7, 29, 35, 53, 60, 72, 87, 108, 116, 126, 128, 129, 130, 131, 134, 136, 138, 142, 156, 161, 165, 178, 182, 185, 189, 192, 195, 197, 202, 210, 214, 217, 221, 234, 243, 246, 269, 303, 310, 337, 340, 374, 401, 419, 438, 475 and 476. Preferred mutations include S243Q, S125A, N128C, T131I, T165I, K178L, T182G, F202Y, Y305R, D319T and G475K or combinations thereof. Further suitable amylases can be found in WO2010/115028 and WO2010/115021.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, Preferenz S100® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

In one aspect, such additional enzyme may be selected from the group consisting of: lipases, including “first cycle lipases” such as those described in U.S. Pat. No. 6,939,702 B1 and US PA 2009/0217464. In one aspect, the lipase is a first-wash lipase, preferably a variant of the wild-type lipase from Thermomyces lanuginosus comprising at least one mutation in positions 232 and 233, preferably two mutations. In one aspect said enzyme comprises both T231R and N233R mutations. The wild-type sequence is the 269 amino acids (amino acids 23-291) of the Swissprot accession number Swiss-Prot O59952 (derived from Thermomyces lanuginosus (Humicola lanuginosa)). Preferred lipases would include those sold under the tradenames Lipex®, Lipoclean® and Lipolex®.

In one aspect, other preferred enzymes include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID N0:2 in 7,141,403B2) and mixtures thereof. Suitable endoglucanases are sold under the tradenames Celluclean® and Whitezyme® (Novozymes A/S, Bagsvaerd, Denmark).

Other preferred enzymes include pectate lyases sold under the tradenames Pectawash®, Pectaway®, care cellulases sold under the tradenames Carezyme®, Carezyme Premium® and under the Biotouch tradename (AB Enzymes) and mannanases sold under the tradenames Mannaway® (all from Novozymes A/S, Bagsvaerd, Denmark), and Purabrite® (Genencor International Inc., Palo Alto, Calif.).

The enzyme may be in the form of a stabilized enzyme particle. The stabilized enzyme particles can have either a core/coating design wherein the enzyme particles comprise a central core and one or more coatings substantially surrounding the core, or a layered granule design made by a fluid bed process.

Core/coating enzyme particles comprise a core substantially surrounded by one or more coatings. These one or more coatings reduce the risk of enzyme dust release as a result of abrasion, and further protect the enzyme core from ingress, such as water ingress. In one embodiment, the core substantially comprises an enzyme. In another embodiment, the core may comprise salts, efflorescent agents, binding agents, kaolin/CaCO₃ and cellulose fibers, in addition to the enzyme. In one embodiment, the core comprises an enzyme and the efflorescent agent sodium sulphate. Enzymes suitable for use in the core are discussed in more detail below.

The one or more coatings on the enzyme particles may comprise polymers, pigments (to improve visual appearance), further excipients, antioxidants, and mixtures thereof. Suitable coatings include polymers such as polyethylene glycol, hydroxypropylmethylcellulose (HPMC), polyvinylalcohol (PVA), carboxymethyl cellulose, methyl cellulose, hydroxyethyl cellulose, hydroxypropyl cellulose and corresponding mixed ethers, gelatin, casein, polyacrylates, polymethacrylates, copolymers of acrylic acid with maleic acid, or vinyl group-containing compounds, partially saponified polyvinyl acetate and polyvinylpyrrolidone. In one embodiment, the polymer is a polyethylene glycol having a molecular weight of from about 300 to about 10,000, in another embodiment from about 2,000 to about 6,000. Suitable pigments may be agents that either provide a distinct colour or are whitening agents such as titanium dioxide. Suitable excipients include starches, sugars, sodium carbonate, calcium carbonate, silica, titania, alumina, clays such as bentonite, and/or talc. Suitable antioxidants may be selected from the group consisting of sodium sulphite, reducing sugars, ascorbic acid, tocopherol, gallates, thiosulfate, substituted phenols, hydroquinones, catechols, and aromatic amines and organic sulfides, polysulfides, dithiocarbamates, phosphites, phosphonates, vitamin E, catalase, low molecular weight peptides, and mixtures thereof. These antioxidants essentially act as sacrificial substrates to protect the enzyme particle.

In one embodiment, the coating comprises polyethylene glycol, kaolin, and titanium dioxide (white pigment). In one embodiment, a second coating of efflorescent agent, in one embodiment sodium sulphate, at least partially surrounds the coating comprising polyethylene glycol, kaolin, and titanium dioxide (white pigment). In one embodiment, the efflorescent agent is sodium sulphate and is present at a level of from about 30% to about 80%, or from about 40% to about 75%, or from about 50% to about 65%, by weight of the enzyme particle. Suitable core/coating designs include the grades sold as GT, Evity and GTX by Novozymes.

In another embodiment, the enzyme particles have a layered granule structure that can be made via fluid bed processing. In one embodiment, the core comprises a central part substantially free of enzymes, and a layer surrounding the central part of the core comprising enzymes. The surrounding layer, in addition to comprising enzymes, may comprise other stabilizers such as antioxidants. In addition to the core comprising a central part and a surrounding layer, the enzyme particle may comprise a shell substantially contacting the surrounding layer. In one embodiment, the shell comprises a plurality of layers, the outer most layer of the granule being a protective layer. In one embodiment, the central part of the core and at least one of the layers of the shell comprises an efflorescent material.

The central part of the core preferably comprises from about 1% to about 60%, in another embodiment from about 3% to about 50%, and another embodiment from about 5% to about 40% by weight of the total enzyme particle. In one embodiment, the central core is sodium sulphate. In one embodiment, the layer comprising the efflorescent material represents from about 0.5% to about 40%, in another embodiment from about 1% to about 30%, and in another embodiment from about 3% to about 20% by weight of the total enzyme particle. In one embodiment the most outer layer of the shell comprises polyvinyl alcohol, optionally titanium oxide (for aesthetic reasons) and combinations thereof. The protective layer of the shell comprises from about 0.05% to about 20%, in another embodiment from about 0.1% to about 15% and in another embodiment from about 1% to about 3% by weight of the total enzyme particle. The enzyme particle may also contain adjunct materials such as:
(a) excipients including starches, sugars, sodium carbonate, calcium carbonate, silica, titania, alumina, clays such as bentonite, and/or talc.
(b) antioxidants including sodium sulphite, reducing sugars, ascorbic acid, tocopherol, gallates, thiosulfate, substituted phenols, hydroquinones, catechols, and aromatic amines and organic sulfides, polysulfides, dithiocarbamates, phosphites, phosphonates, vitamin E, catalase, low molecular weight peptides, and mixtures thereof.

Enzyme particles according to this embodiment can be made by a fluid bed layering process similar to that described in U.S. Pat. No. 5,324,649, U.S. Pat. No. 6,602,841 B1 and US2008/0206830A1.

Regardless of the process of making, the enzyme particles have a weight geometric mean particle size of from about 200 μm to about 1200 μm, in another embodiment from about 300 μm to about 1000 μm, and in another embodiment from about 400 μm to about 600 μm.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

At least one composition, preferably a powder composition comprises a coated bleach, preferably a coated percarbonate and a coated enzyme. Without wishing to be bound by theory, it was surprisingly found that the activity of the enzyme was improved wherein it was coated and in the presence of a coated percarbonate.

Exemplary anionic surfactants are the alkali metal salts of C₁₀-C₁₆ alkyl benzene sulfonic acids, or C₁₁-C₁₄ alkyl benzene sulfonic acids. In one aspect, the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially useful are the sodium and potassium linear straight chain alkylbenzene sulfonates in which the average number of carbon atoms in the alkyl group is from about 11 to 14. Sodium C₁₁-C₁₄, e.g., C₁₂, LAS is a specific example of such surfactants.

Specific, non-limiting examples of anionic surfactants useful herein include: a) C₁₁-C₁₈ alkyl benzene sulfonates (LAS); b) C₁₀-C₂₀ primary, branched-chain and random alkyl sulfates (AS), including predominantly C₁₂ alkyl sulfates; c) C₁₀-C₁₈ secondary (2,3) alkyl sulfates having formulae (I) and (II): wherein M in formulae (I) and (II) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of suitable cations including sodium, potassium, ammonium, and mixtures thereof, and x is an integer of at least about 7, or at least about 9, and y is an integer of at least 8, or at least about 9; d) C₁₀-C₁₈ alkyl alkoxy sulfates (AEₓS) wherein x is from 1-30; e) C₁₀-C₁₈ alkyl alkoxy carboxylates in one aspect, comprising 1-5 ethoxy units; f) mid-chain branched alkyl sulfates as discussed in U.S. Pat. No. 6,020,303 and U.S. Pat. No. 6,060,443; g) mid-chain branched alkyl alkoxy sulfates as discussed in U.S. Pat. No. 6,008,181 and U.S. Pat. No. 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); and j) alpha-olefin sulfonate (AOS).

A suitable anionic detersive surfactant is predominantly alkyl C₁₆ alkyl mid-chain branched sulphate. A suitable feedstock for predominantly alkyl C₁₆ alkyl mid-chain branched sulphate is beta-farnesene, such as BioFene™ supplied by Amyris, Emeryville, Calif.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. In one aspect, R¹ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain on average from about 2 to 12 ethylene oxide moieties per molecule, or from about 3 to 10 ethylene oxide moieties per molecule.

The compositions may comprises a dye. Dyes including substantive and non-substantive dyes. Substantive dyes in include hueing dyes. The hueing dyes employed in the present laundry detergent compositions may comprise polymeric or non-polymeric dyes, pigments, or mixtures thereof. Preferably the hueing dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The hueing dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present invention, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The hueing dye may be introduced into the composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

The dye may be a non-substantive dye, such as an aesthetic dye. Preferably, the liquid composition comprises a non-substantive dye having an average degree of alkoxylation of at least 16. Each composition maybe coloured. The colour of each composition may be the same or different to one another. The powder composition may comprise a coloured speckle or particle. The speckle or particle may comprise a pigment. The colour of the speckle and the colour of the liquid composition may be the same or different.

The compositions may comprise a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein. Preferably, the chelant is present in the powder composition. Without wishing to be bound by theory, there is a tendency for chelants to crystallize at higher levels in liquid compositions. Higher levels are desirable to help maintain cleaning performance in the wash liquor.

The compositions may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

The compositions may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS−DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Suitable suds suppressors include silicone and/or fatty acid such as stearic acid.

### Water-Soluble Film

The film of the unit dose article is soluble or dispersible in water, and preferably has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred film materials are polymeric materials. The film material can be obtained, for example, by casting, blow-moulding, extrusion or blown extrusion of the polymeric material, as known in the art. Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000. Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material. Preferred films exhibit good dissolution in cold water, meaning unheated water straight from the tap. Preferably such films exhibit good dissolution at temperatures below 25° C., more preferably below 21° C., more preferably below 15° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310, films described in U.S. Pat. No. 6,166,117 and U.S. Pat. No. 6,787,512 and PVA films of corresponding solubility and deformability characteristics. Further preferred films are those describes in US2006/0213801, WO 2010/119022, US2011/0188784 and U.S. Pat. No. 6,787,512.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including water, to be delivered to the wash water, for example organic polymeric dispersants, etc.

The film may be lactone free. By this we mean that the film does not comprise any lactone. Alternatively, the film may comprise very low levels of lactone that are present due to impurities but which have not been deliberately added. However, essentially the film will be free of lactone.

The film may be opaque, translucent or transparent.

The film comprised in the unit dose article may have a thickness of between 10 and 200 μm, or even between 15 and 150 μm, or even between 20 and 100 μm.

### Method of Use

The present invention is also to a process for the machine washing of laundry using an article according to the present invention, comprising the steps of, placing at least one article according to the present invention into the washing machine along with the laundry to be washed, and carrying out a washing or cleaning operation.

Any suitable washing machine may be used. Those skilled in the art will recognize suitable machines for the relevant wash operation. The article of the present invention may be used in combination with other compositions, such as fabric additives, fabric softeners, rinse aids and the like.

The wash temperature may be 30° C. or less. The wash process may comprise at least one wash cycle having a duration of between 5 and 20 minutes. The automatic laundry machine may comprise a rotating drum, and wherein during at least one wash cycle, the drum has a rotational speed of between 15 and 40 rpm, preferably between 20 and 35 rpm.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

The benefit of a unit dose article according to the present invention was tested versus one outside of the scope.

A liquid composition was prepared in a 1 L beaker, stirred at 250 rpm with a 10 cm diameter impeller. The liquid composition comprised;

6.31 wt % water

### 13.81 wt % 1,2-Propanediol

### 5.67 wt % Glycerol

20.54 wt % MEA-linear alkylbenzene sulphonate
10.04 wt % ethoxylated alkyl sulphate with an average degree of ethoxylation of 3
14.84 wt % ethoxylated fatty alcohol ethoxylate with an average degree of ethoxylation of 7
0.75 wt % citric acid
6.97 wt % fatty acid

### 2.38 wt % HEDP

6.13 wt % ethoxylated polyethylene imine
0.0585 wt % protease (54.4 mg/g)
0.09 wt % sodium formate
0.62 wt % minors

### 0.36 wt % MgCl₂

### 0.11 wt % K₂SO₃

1.81 wt % perfume
0.018 wt % brightener 49
9.49 wt % monoethanolamine

A powder composition was then prepared comprising 0.15 g TAED and 1.05 g sodium percarbonate.

A first unit dose article was then prepared by deforming a piece of M8630 film (commercial available from Monosol) in a mould having a geometry according to the present invention for 10 seconds and then applying a vacuum at 400 mBar. Into the larger outer compartment, 30 ml of the powder was added using a 5 ml syringe. In the smaller inner compartment the powder was added using a spatula. A water based solvent was then applied to the seal area and a second film was used to close the unit dose article and sealed for 17 seconds at 120° C.

A second unit dose article was then prepared having a first and a second compartment wherein the compartments were arranged next to one another but wherein the first compartment did not surround the second compartment. This the two compartments faced one another along one side of each compartment only. The first film was prepared as above in an appropriate mold and 22 ml of the liquid composition added to a first compartment. This lower volume was necessary due to the difference in compartment size which was a consequence of the geometry of the unit dose article. To the second compartment, the powder was added together with 2 g of carbonate as a filler. This was added again due to difference in compartment volume due to the geometry of the unit dose articles. A second film was added and the unit dose article sealed as described above.

A third unit dose article was prepared in the same way as the first unit dose article, but comprised 2.24 g sodium HEDP in the powder compartment instead of the powder of the first unit dose article.

A fourth unit dose article was prepared in the same way as the second unit dose article, but comprised 2.24 g sodium HEDP and 2.05 g carbonate filler in the powder compartment instead of the powder of the second unit dose article.

A fifth unit dose article was prepared in the same way as the first unit dose article but comprised 1.05 g of a 15% active hueing dye instead of the powder of the first unit dose article.

A sixth unit dose article was prepared in the same way as the second unit dose article but comprised 1.05 g of a 15% active hueing dye and 0.5 g carbonate instead of the powder of the second unit dose article.

| Unit dose article | Liquid | Powder | Mold |
|---|---|---|---|
| 1 | 30 ml | 0.15 g TAED | Present |
| | | 1.05 g Percarbonate | invention |
| 2 | 22 ml | 0.15 g TAED | Outside |
| | | 1.05 g Percarbonate | scope |
| | | 2 g carbonate | |
| 3 | 30 ml | 2.24 g NaHEDP | Present |
| | | | invention |
| 4 | 22 ml | 2.24 g NaHEDP | Outside |
| | | 2.05 g carbonate | scope |
| 5 | 30 ml | 1.05 g VION powder @ | Present |
| | | 15% active | invention |
| 6 | 22 ml | 1.05 g VION powder @ | Outside |
| | | 15% active | scope |
| | | 0.5 g carbonate | |

The unit dose articles were exposed to 20 consumers and the consumers were asked which of the unit dose articles they preferred. Of the 20 consumers, 14 stated that they preferred the unit dose articles having a geometry according to the present invention as opposed to unit dose articles outside of the scope, whilst the remaining 6 preferred unit dose article having a geometry outside of the scope of the present invention.

Of the 14 consumers that preferred unit dose articles according to the present invention, 5 stated that they felt that the powder compartment of the unit dose article outside of scope was not firm and was weak, 3 stated that they feared the powder compartment of the unit dose article out of scope could accidentally open, 2 stated that the unit dose article out of scope was ‘floppy’, 3 stated that they did not like the ‘hanging’ look of the second compartment of the unit dose article out of scope and 2 stated that they felt the compartments of the unit dose article out of scope could separate and did not feel like one single unit, 2 stated that they felt their impression (without testing) was that the unit dose article outside of the scope tad less product′ and washed less profoundly.

As has been demonstrated consumers preferred the unit dose article of the presrnt invention compared to one outside of the scope.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within

What is claimed is:

1. A multicompartment water-soluble unit dose article comprising a water-soluble film,
wherein a first compartment comprises a powder composition, wherein the powder composition comprises a calcium carbonate crystal growth inhibitor selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof;
wherein a second compartment comprises a liquid composition; and
wherein the unit dose article comprises a top wall, a bottom wall, an inner wall and an outer wall, and wherein the first compartment is defined as the internal space between the top wall, the bottom wall and the inner wall, and wherein the second compartment is defined as the internal space between the inner wall, the outer wall, the top wall and the bottom wall, and wherein the walls comprise the water-soluble film, and wherein outer wall remains substantially equidistant to the inner wall along the full length of the inner wall.

2. The unit dose article according to claim 1, wherein the unit dose article comprises a first and a second water-soluble film and wherein the water-soluble films are sealed together.

3. The unit dose article according to claim 1 wherein the first compartment has a substantially square, rectangular, circular, elliptical, superelliptical or oval shape.

4. The unit dose article according to an claim 1 wherein the outer wall surrounds the inner wall.

5. The unit dose article according to claim 1 wherein the calcium carbonate crystal growth inhibitor is 1-hydroxyethanediphosphonic acid (HEDP) or salts thereof.

6. The unit dose article according to claim 1 wherein the second compartment has a generally tubular shape that surrounds the first compartment.

7. The unit dose article according to claim 1, wherein the unit dose article has a height, a length and a width, wherein the maximum height is between about 1 and about 5 cm, the maximum length is between about 2 and about 8 cm, and the maximum width is between about 2 and about 8 cm.

8. The unit dose article according to claim 1, wherein the unit dose article has a maximum height, a maximum length, and a maximum width, and the first compartment has a maximum height, a maximum length and a maximum width and wherein;
a. the ratio of the maximum height of the first compartment to the maximum height of the unit dose article is between about 1:2 and about 2:1;
b. the ratio of the maximum length of the first compartment to the maximum length of the unit dose article is between about 1:1.5 to about 1:3;
c. the ratio of the maximum width of the first compartment to the maximum width of the unit dose article is between about 1:1.5 to about 1:3.

9. The unit dose article according to claim 1 wherein the powder composition comprises a first cleaning active, and wherein the liquid composition comprises a second cleaning active and wherein the first and second cleaning actives are incompatible with one another.

10. The unit dose article according to claim 9, wherein the first cleaning active comprises a bleach, an enzyme or a mixture thereof.

11. The unit dose article according to claim 9, wherein the second cleaning active comprises a cleaning surfactant, a cleaning polymer, a perfume, a dye or a mixture thereof.

12. The unit dose article according to claim 1 wherein the pH of the liquid composition is between about 5 and about 9.

13. The unit dose article according to claim 12 wherein the pH is between about 6 and about 8.

14. The unit dose article according to claim 1, wherein the unit dose article ruptures between about 10 seconds and about 5 minutes once the unit dose article is added to about 950 ml of deionised water at about 20-21° C. in a 1 L beaker, wherein the water is stirred at about 350 rpm with a 5 cm magnetic stirrer bar.

15. The unit dose article according to claim 1, wherein the weight ratio of the first composition to the second composition in the unit dose article is from about 3:1 to about 1:3.

16. A method of laundry comprising the step of adding a unit dose article according to claim 1 to the drum of an automatic laundry washing machine.
